(19) United States
(12) Patent Application Publication
(10) Pub. No.: US 2016/0275293 A1
(43) Pub. Date: Sep. 22, 2016

(54) INFORMATION PROCESSING SYSTEM AND CONTROL METHOD OF THE INFORMATION PROCESSING SYSTEM

(71) Applicant: FUJITSU LIMITED, Kawasaki-shi (JP)

(72) Inventors: Akito YAMAZAKI, Kawasaki (JP); Kazunori KOBASHI, Yamato (JP); Akimasa YOSHIDA, Nagoya (JP); Masnori KIMURA, Mishima (JP); Kei OHISHI, Chigasaki (JP)

(73) Assignee: FUJITSU LIMITED, Kawasaki-shi (JP)

(21) Appl. No.: 15/016,429

(22) Filed: Feb. 5, 2016

(30) Foreign Application Priority Data
Mar. 18, 2015 (JP) 2015-055028

(51) Int. Cl. G06F 21/60

(52) U.S. Cl. CPC G06F 21/60

(57) ABSTRACT

An abstraction unit converts confidential information to alternative information. An association information management unit manages association information that indicates association of the alternative information and the confidential information. A process control unit processes by using the data obtained by converting the confidential information to the alternative information. An investigation information management unit creates investigation information that indicates the operation of a storage device, by using the alternative information and collects the investigation information related to a trouble that has occurred in the storage device from among the pieces of the investigation information. A management server allows, in response to a request from an investigator terminal, the investigation information management unit to collect the investigation information related to the trouble. An SE terminal restores the alternative information included in an investigation result obtained on he basis of the investigation information by using the association information to the confidential information.

### CROSS-REFERENCE TO RELATED APPLICATION

This application is based upon and claims the benefit of priority of the prior Japanese Patent. Application No. 2015-055028, filed on Mar. 18, 2015, the entire contents of which are incorporated herein by reference.

### FIELD

The embodiment discussed herein is directed to an information processing system and a control method of the information processing system.

### BACKGROUND

In recent years, with the popularization of cloud computing, each company increasingly uses resources in data centers provided by cloud service business providers instead of having company's resources, such as servers, storage, or the like. Furthermore, there is a tendency to have a base location in a plurality of countries instead of having data centers in a single country.

Furthermore, in the data centers, it is desirable to implement, an outsourcing service (hereinafter, referred to as a “one stop service”) that has a function of providing various kinds of services at one stop without receiving geographical and physical constraints. The one atop mentioned here indicates a state in which various services can be received in a single location. To implement this type of service, it is desirable to efficiently operate and manage systems distributed in a plurality of countries or regions.

Furthermore, if a trouble occurs in a data center that provides this type of service, customer unique information may possibly be included in investigation information that is acquired by an investigator of the trouble and thus the reliability of the data center may possibly be threatened.

Conventionally, in a system that provides a one stop service, the following process is performed. If a trouble occurs during a process that uses information on a specific user who uses a data center, an administrator of the data center requests a business provider that provides the one stop service, (hereinafter, simply referred to as a “business provider”) to investigate the trouble. Furthermore, the administrator of the data center also notifies the engineer who performs the handling, such as giving an explanation to the specific user, of the occurrence of the trouble.

The investigator in the business provider acquires investigation information from the data center for the investigation In the investigation information, for example, an operation log, a configuration DB, and the like are included. The investigator investigates on the basis of the acquired investigation information and stores the investigation result in a database that is used for trouble investigations (hereinafter, referred to as a “trouble investigation database (DB)”) managed by the business provider. Then, the investigator notifies the administrator of the data center of the completion of the investigation.

The administrator of the data center notifies the engineer who performs the handling, such as giving an explanation to the specific user, of the completion of the investigation. In response to the notification, the engineer who performs the handling, such as giving an explanation to the specific user, explains the trouble to the specific user on the basis of the investigation result stored in the trouble investigation DB.

In the investigation information acquired by the investigator from the data center when the investigator performed a process of handling the trouble, it is conceivable that information with a high s level hereinafter referred to as “confidential information”) for the user is included. Even if only the investigator handles the investigation information, the information may possibly be leaked due to an error or interference from another person. Consequently, include the confidential information in the investigation information in a readable state leads to a decrease in the security level.

Furthermore, if the one stop service across a plurality of data centers, the confidential information may possibly be distributed to each of the data centers. If the investigation information is collected in this environment, the confidential information may possibly flow through a network and thus it is difficult to suppress a decrease in the security level.

Accordingly, in order to handle the decrease in the security level, there is a conventional technology that sets a disclosure target for each contact person, that encrypts information by an encryption key that is different for each type of target, and that provides the encryption key to the contact person. Furthermore, there is a conventional technology that extracts confidential information from a log and that encrypts the confident information.

Patent Document 1: Japanese Laid-open Patent Publication No. 2007-200059

Patent Document 2: Japanese Laid-open Patent Publication No. 2011-237975

However, with the conventional technology that provides an encryption key to an investigator, the confidential information becomes a readable state; therefore, it is difficult to suppress a decrease in the security level. Furthermore, even if the conventional technology that extracts confidential information from a log and that encrypts the confidential information is used, because the confidential information is treated in a readable state in a normal operation; therefore, it is also difficult to suppress a decrease in the security level.

### SUMMARY

According to an aspect of an embodiment, an information processing system includes: an information processing apparatus that processes data that is input; a management device that manages the information processing apparatus; a first terminal device; and a second terminal device, wherein the information processing apparatus includes a converting unit that converts confidential in included in the data to alternative information, an association information management unit that manages association information that indicates the association of the alternative information which is created by the converting unit and the confidential information, a process control unit that performs a process by using the date obtained by converting the confidential information to the alternative information, and an investigation information management unit that creates, by using the alternative information, investigation information indicating the operation of the information processing apparatus and that collects, from among the pieces of the investigation. information, investigation information related to a trouble that has occurred in the information processing apparatus, and the management device includes a collection instruction unit that causes the investigation information management unit to collect, in accordance with an acquisition request for the investigation information related to the trouble that has occurred in the information processing apparatus received from the first terminal device, the investigation information related to the trouble, and the second terminal device restores the alternative information included in an investigation result obtained on the basis of the investigation information to the confidential information by using the association information.

The object and advantages of the invention will be realized and attained by means of the elements and combinations particularly pointed out in the claims.

It is to be understood that both the foregoing general description and the following detailed description are, exemplary and explanatory and are not restrictive of the invention, as claimed.

### BRIEF DESCRIPTION OF DRAWINGS

FIG. 1 is a schematic diagram illustrating the configuration of an information processing system;

FIG. 2 is a block diagram illustrating a control server, a storage device, and a management server;

FIG. 3 is a schematic diagram illustrating an example of an input screen of employee information;

FIG. 4 is a schematic diagram illustrating an example of an abstraction association table;

FIG. 5 is a schematic diagram illustrating an example of a customer management table;

FIG. 6 is a schematic diagram illustrating an example of a trouble management table;

FIG. 7 is a schematic diagram illustrating an example of data storage location management table;

FIG. 8 is a timing chart of a data storing process performed when data is input first time;

FIG. 9 is a timing chart of the data storing process performed when data is updated;

FIG. 10A is a timing chart of a process of hand handling a trouble performed when the trouble occurs;

FIG. 10B is a timing chart of a process of handling a trouble performed when the trouble occurs;

FIG. 11 is a timing chart of a duplicating process of data between data centers;

FIG. 12 is a timing chart of a process of providing a is e after the data center is changed; and

FIG. 13 is a block diagram illustrating the hardware configuration of the data center.

### DESCRIPTION OF EMBODIMENTS

Preferred embodiments of the present invention will be explained with reference to accompanying drawings. The information processing system and the control method of the information processing system disclosed in the present invention is not limited to the embodiment described below.

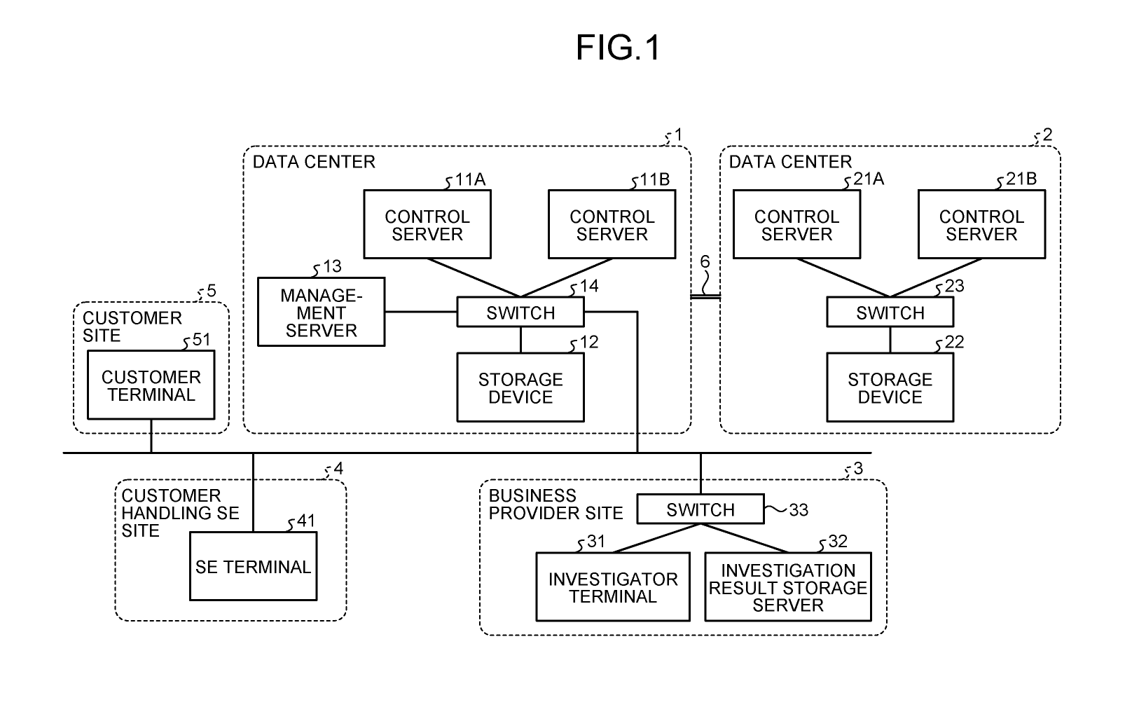

FIG. 1 is a schematic diagram illustrating the configuration of an information processing system. A data center 1, a data center 2, a business provider site 3, a customer handling system engineer (SE) site. 4, and a customer site 5 each illustrated in FIG. 1 represent the base location of the system managed by handling persons, corporations, or the like. Namely, an information processing system according to the embodiment includes base location of the system i.e., the data center 1, the data center 2, the business provider site 3, the customer handling SE site 4, and the customer site 5.

Specifically, the data centers 1 and 2 are the base locations o the corporation that at includes the system that provides various kinds of information processing devices, such as management of data or the like. The information processing device provided by the data centers 1 and 2 is for example, software as a service (SaaS) or the like. In the embodiment, a description will be given of a case in which, the data centers 1 and 2 provide an employee information management service. The data centers 1 and 2 may also be set in different countries.

Furthermore, the data centers 1 and 2 are connected by a private network 6 or the like.

The business provider site 3 is the base location of a corporation that includes a system that investigates the cause of a failure in the data center 1.

The customer site 5 is the base location of the system that is used by users of the services provided by the data center 1 and the data center 2.

The customer handling SE site 4 is the base location of the system owned by a company that performs a technical support, with respect to the customer site 5, related to the data centers 1 and 2 or the system owned by a person.

The data center 1, the business provider site the customer handling SE site 4, and the customer site 5 are connected with each other by, for example, the Internet.

The data center 1 includes a control server 11A, a control server 11B, a storage device 12, a management server 13, and a switch 14. Each of the control server 11A the control server 118, the storage device 12, and the management server 13 is connected via the switch 14. Furthermore, the switch 14 is connected to an external network, such as the Internet or the like.

The control servers 11A and 11B control the storage device 12 and provide an employee information management service. In response to an input received from the customer terminal (an information processing apparatus for a customer) 51, the control servers 11A and 11B provide services, such as the writing or the reading of the employee information, by using the storage device 12. Both of the control servers 11A and 11B provide the same services. In a description below, when the control servers 11A and 11B are not distinguished, the control server is simply referred to as a “control server 11”. In the embodiment, a description will be given of a case in which the number of the control servers 11 is two, i.e., the control servers 11A and 11B; however, the number of the control servers 11 is not particularly limited thereto.

The control servers 11 may also provide a service by using physical servers as a single server; however, it may also possible to configure a plurality of virtual machines inside the system, allocate each of the virtual machines to a customer, and provide a service.

The storage device 12 includes a high-capacity storage medium. In response to an instruction received from the control server 11, the storage device 12 writes and reads data.

The management server 13 manages the control servers 11 and the storage device 12 arranged in the data center 1. Furthermore, the management server 13 also manages control servers 21A and 21B and a storage device 22 arranged in the data center 2. For example, in response to an instruction received from the customer terminal 51, the management server 13 performs the setting of customer information with respect to the control servers 11 and the storage device 12, the setting of a virtual machine to be allocated to customers, the setting of an SE terminal 41 that takes care of the customers. Furthermore, the management server 13 duplicates data for redundancy between the data center 1 and the data center 2. The management server 13 mentioned here corresponds to an example of a “management device”.

In the embodiment, a description will be given of a case in which the data center 2 is present in a country that is different from the country in which the data center 1 is present. The data center 2 includes the control servers 21A and 21B, the storage device 22, and a switch 23. The control servers 21A and 21B have the same function as that performed by the control servers 11. In a description below, when the control servers 21A and 21B are not distinguished, the control, servers are simply referred to as a “control server 21”. Furthermore, the storage device 22 has the same function as that performed by the storage device 12. Furthermore, the switch 23 has the same function as that performed by the switch 14. The storage devices 12 and 22 mentioned here correspond to an example of an “information processing apparatus”.

The business provider site 3 includes an investigator terminal (information processing apparatus used for an investigator) 31, an investigation result storage server 32, and a switch 33. The investigator terminal 31 and the investigation result storage server 32 are connected to the Internet via the switch 33.

The investigator terminal 31 is a computer used by an investigator who investigates, when, for example, a trouble occurs in the data center 1, in order to find out the cause of the trouble or to perform the handling for a recovery. The investigator terminal 31 receives a request for the investigation from the management server 13 and submits the received request to the investigator. Then, response to the operation instruction received from the investigator, the investigator terminal 31 acquires an investigation reference material from the control server 11 and provides the material to the investigator by, for example, displaying the investigation reference material on a display. Thereafter, in response to an instruction receive d from the investigator, the investigator terminal 31 stores he investigation result in the investigation result storage server 32. The investigator terminal 31 mentioned here corresponds to an example of a “first terminal device”.

The investigation result storage server 32 receives an input of the investigation result of the investigation performed by the investigator from the investigator terminal 31 and stores the investigation result.

The customer handling SE site 4 includes the SE terminal (an information processing apparatus used for a handling person) 41. The SE terminal 1 is a computer that is used by a customer handling SE who takes care of a customer. The SE terminal 41 receives a notification of the occurrence of a trouble from the management server 13 and sends the notification to the customer handling SE. Thereafter, the SE terminal 41 receives a notification of the completion of the investigation of the trouble from the management server 13 and sends the notification to the customer handling SE. In response to the operation instruction received from the customer handling SE, the SE terminal 41 acquires the investigation result from the investigation result storage server 32 and provides the investigation result to the customer handling SE by, for example, displaying the investigation result on a display. The customer handling SE explains the trouble to the customer by using the investigation result provided from the SE terminal 41. The SE terminal 41 mentioned here corresponds to a “second terminal device”.

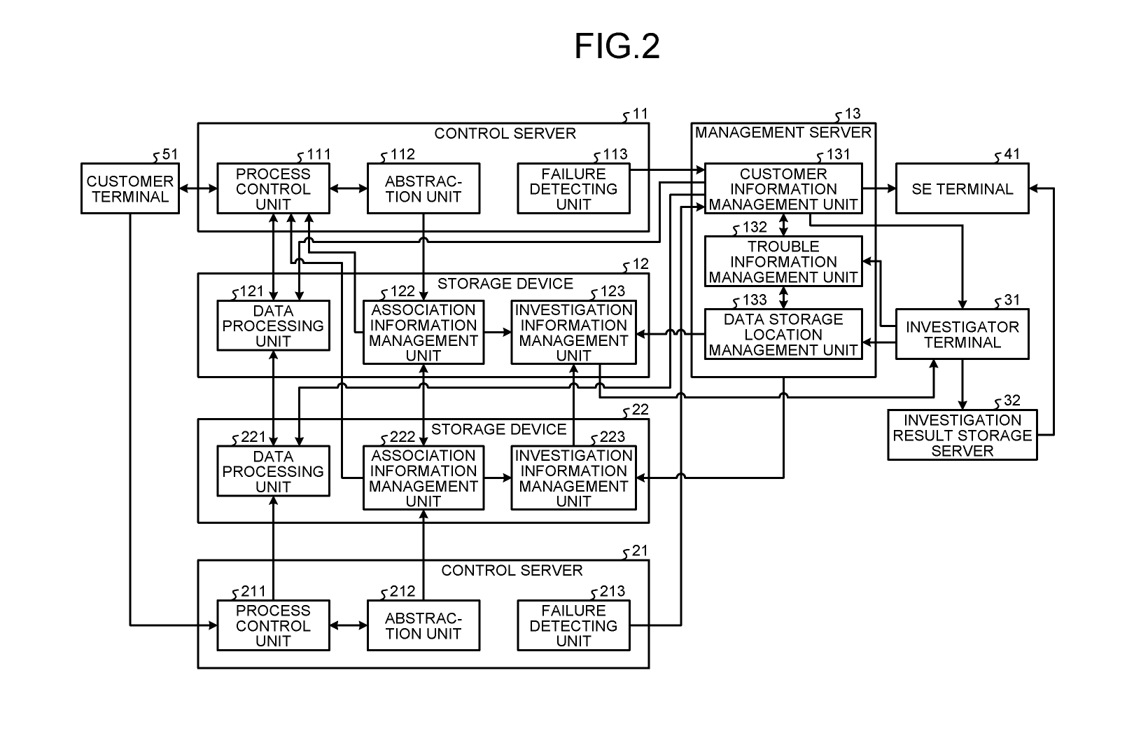

In the following, the process performed by the data center according to the embodiment will be described with reference to FIG. 2. FIG. 2 is a block diagram illustrating a control server, a storage device, and a management server.

The control server 11 includes a process control unit 111, an abstraction unit 112, and a failure detecting unit 113. Furthermore, the storage device 12 includes a data processing unit 121, an association information management unit 122, and an investigation information management unit 123. Furthermore, the management server 13 includes a customer information management unit 131, a trouble information management unit 132, and a data storage location management unit 133.

The process control unit 111 performs a process related to a service to be provided. Specifically, the process control unit 111 receives a write request for data from the customer terminal 51. The process control unit 111 stores therein the determination reference that is used to determine which of data requested to be written is treated as confidential information with a high security level. The Information with a high security level mentioned here is information, such as personal information or the like, that is suitable for treating as non-public information. Then, the process control unit 111 extracts the confidential information from the data specified by the write request and then sends the confidential information to the abstraction unit 112.

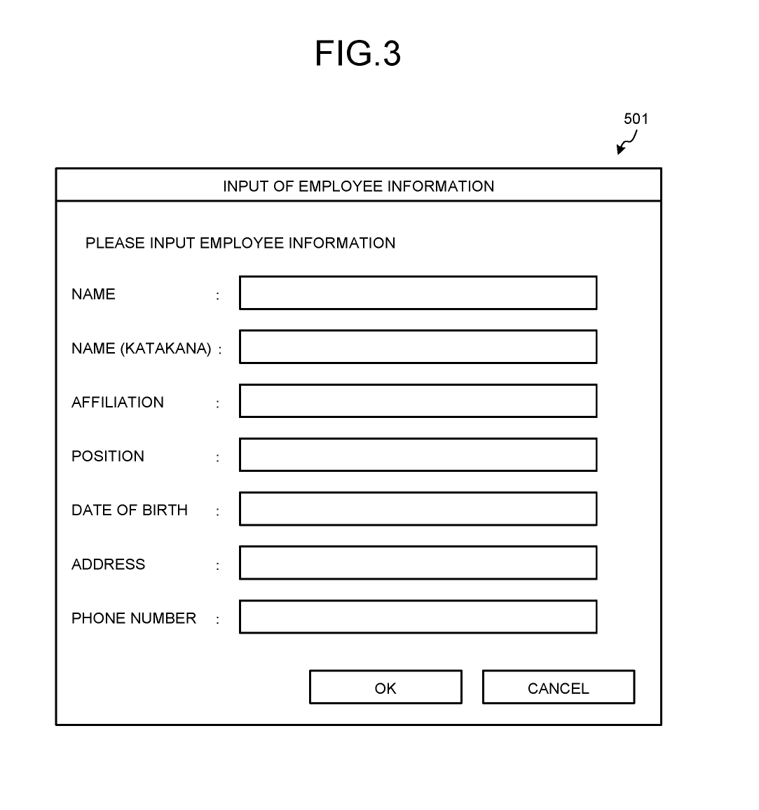

For example, the process control unit 111 receives the write request for the data that is input by using an input screen 501 illustrated in FIG. 3 from the customer terminal 51. FIG. 3 is a schematic diagram illustrating an example of an input screen of employee information. The process control unit 111 stores therein, in advance, an entry field of the information that needs to be input as confidential information on the input screen 501. For example, the process control unit 111 extracts, as the confidential information, the information described in the field of each of the name, the name (Katakana), the address, and the phone number on the input screen 501.

Then, the process control unit 111 requests the abstraction unit 112 to abstract the confidential information. Thereafter, the process control unit 111 receives the abstracted confidential information (hereinafter, referred to as “abstraction data”) from the abstraction unit 112. Then, the process control unit 111 replaces the confidential information in the data specified by the write request with abstraction data. Thereafter, the process control unit 111 allows the data processing unit 121 to write the data in which the confidential information is replaced with the abstraction data. Namely, the data stored in the storage area in the data processing unit 121 becomes the data in which the confidential information is replaced with the abstraction data. The storage area is a storage area that is provided by a hard disk drive (HDD), a solid state drive (SSD), a magnetic tape, or the like.

Furthermore, the process control unit 111 receives a read request for date from the customer terminal 51. Then, the process control unit 111 acquires the data specified by the read request from the data processing unit 121. Then, from abstraction association data that indicates the association between the confidential information and the abstraction data stored in the association information management unit 122, the process control unit 111 acquires the confidential information that is associated with the abstraction data in the read data. Then, the process control unit 111 converts the abstraction data in the read data to the confidential information and then sends the confidential information to the customer terminal 51.

The abstraction unit 112 receives an input of the confidential information from the process control unit 111. Then, the abstraction unit 112 abstracts the received confidential information and creates abstraction data. Here, any method cart be used for a method of creating the abstraction data performed by the abstraction unit 112 as long as the confidential information before the abstraction can be easily conceived from the created abstraction information. For example, if the information is the identification information on a user, a prefix is determined on the basis of the type of confidential information, such as a “customer” or the like, and then a number may also be allocated by using the sequence, numbers. Furthermore, instead of using a simple replacement of the character string, the abstraction unit 112 may also create abstraction data by encrypting the confidential information.

Then, the abstraction unit 112 sends the association information that indicates the association relationship between the confidential information and the abstraction data to the association information management unit 122. Furthermore., the abstraction unit 112 sends the created abstraction data to the process control unit 111.

The failure detecting unit 113 detects the failure that has occurred in the control server 11. If the failure detecting unit 113 detects the failure, the failure detecting unit 113 notifies the customer information management unit 131 that the trouble has occurred.

The data processing unit 121 receives, from the process control unit 111, an instruction to write data together with the data that was replaced with the abstraction data from the confidential information. Then, the data processing unit 121 writes, in the storage area in the storage device 12, the data that is obtained by rewriting the confidential information to the abstraction data.

Then, the data processing unit 121 receives an instruction to copy the data from the customer information management unit 131. Then, the data processing unit 121 sends the data to a data processing unit 221 in the storage device 22 and instructs to copy the data. Thereafter, the data processing unit 121 receives a completion notification of the data copy from the data processing unit 221 and completes the writing of the data.

Furthermore, if the data processing unit 221 in the storage device 22 performs the writing of the data, the data processing unit 121 receives, from the data processing unit 221 together with the data, an instruction to copy the data. Then, the data processing unit 121 copies the received data in the storage area in the storage device 12. Thereafter, after the completion of the copy, the data processing unit 121 sends the completion notification of the copy of the data to the data processing unit 221.

Furthermore, the data processing unit 121 receives a read instruction from the process control unit: 111. Then, the data processing unit 121 acquires, from the storage area in the storage device 12, the data specified by the read instruction and then sends the data to the process control unit 111.

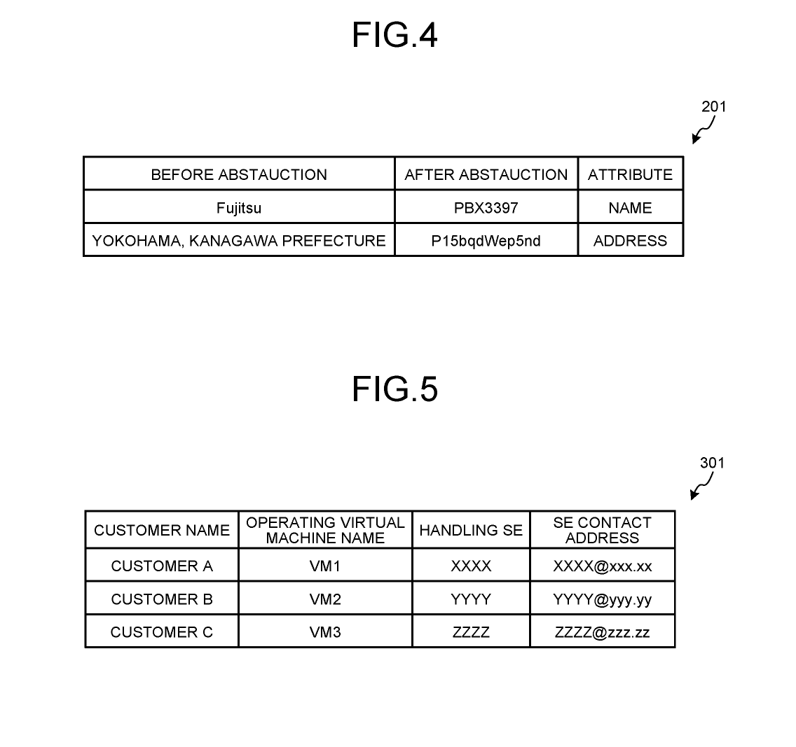

If the data needs to be written, the association information management unit 122 receives the association relationship between the confidential information and the abstraction data from the abstraction unit 112. Them, the association information management unit 122 stores the received association relationship in an abstraction association table. Consequently, the association information management unit 122 holds an abstraction association table 201 illustrated in FIG. 4. FIG. 4 is a schematic diagram illustrating an example of an abstraction association table.

For example, as illustrated in FIG. 4, the association information management unit 122 stores, in an associated manner in the abstraction association table 201, the confidential information that has not been subjected to abstraction and the abstracted abstraction data. Furthermore, the association information management unit 122 may also associate the confidential information with the at tribute that indicates the type of abstracted confidential information and then store the associated information in the data, processing unit 121. In this case, for example, the process control unit ill determines the attribute of the data and the association information management unit 122 receives, from the abstraction unit 112, the information on the attribute of the confidential information determined by the process control unit 111.

Then, the association information management unit 122 sends the information stored in the abstraction association table to an association information management unit 222 in the storage device 22. Furthermore, the association information management unit 122 sends the abstraction data to the investigation information management unit 123. Furthermore, if the association information management unit 222 in the storage device 22 newly registers the association relationship between the confidential information and the abstraction data in the abstraction association table, the association information management unit 122 receives the newly registered information from the association information management unit 222. Then, the association information management unit 122 registers the association relationship between the received confidential information and the abstraction data in the abstraction association table. Consequently, the abstraction association table included in the association information management unit 122 can be synchronized with the abstraction association table included in the association information management unit 222 and both the association information management unit 122 and the association information management unit 222 can holds the abstraction as tables that have the same content and that is redundant.

The investigation information management unit 123 receives an input of the abstraction data from the association information management unit 122. Then, the investigation information management unit 123 creates investigation information by using the acquired abstraction data. The investigation in mentioned here includes the information that is used to find out the cause of a trouble or that is used to determine a handling method or the like, such as an operation log or the like. The investigation information management unit 123 repeatedly creates the investigation information when the control servers 11 and the storage device 12 are being operated. For example, if the control servers 11 and the storage device 12 perform a process of writing and reading the data, the investigation information management unit 123 creates the operation log representing the execution and the completion of the process as the investigation information. At this point, because the investigation information management unit 123 creates the investigation information by using the abstraction data, in the investigation information, the confidential information is included in the form of the abstracted abstraction data.

Furthermore, if a trouble is handled, the investigation information management unit 123 receives, from the data storage location management wait 133, an instruction to collect the investigation information related to the customer targeted for the investigation. Then, the investigation information management unit 123 collects the investigation information related to the specified customer from the stored investigation information.

Furthermore, if the customer also uses the data center 2, the investigation information management unit 123 receives an input of the investigation information related to the customer in the data center 2 from an investigation information management unit 223 in the storage device 22. In this case, the investigation information management unit 123 merges the investigation information on the customer in the data center 1 with the investigation information on the customer in the data center 2 and sets the investigation information as a single piece of investigation information.

Then, the investigation information management unit 123 sends the investigation information to the investigator terminal 31. At this point, for the investigation information to be sent to the investigator terminal 31, the confidential information is also included in the form of the abstraction data that has been subjected to the abstraction.

The customer information management unit 131 previously stores therein identification information, such as the name of the customer, the account of the customer, or the like, and the customer information, such as a password, a virtual machine to be used, a customer handling SE, or the like. For example, the customer information management unit 131 stores therein a customer management table 301 illustrated in FIG, 5. FIG. 5 is a schematic diagram illustrating an example of a customer management table. In the customer management table 301, the customer name as the identification information on a customer, the name of a running virtual machine allocated to a customer, identification information on the handling SE, and an SE contact address are registered.

If a trouble occurs in the control server 11, the customer information management unit 131 receives a notification of the occurrence of the trouble from the failure detecting unit 113 together with the identification information on the customer. Furthermore, if a trouble occurs in the control server 21, the customer information management unit 131 receives a notification of the occurrence of the trouble from a failure detecting unit 213 together with the customer information. Here, a description will be given of a case in which the customer Information management unit 131 receives a customer name as the identification information on the customer. The customer information management unit 131 acquires, from the customer management table 301, information on the customer handling SE of the customer with the notified customer name.

Furthermore, the customer information management unit 131 notifies the trouble information management unit 132 of the customer name. Then, the customer information management unit 131 receives, from the trouble information management unit 132 together with the trouble number, a notification indicating that an issue of a trouble number has been completed.

Then, the customer information management unit. 131 notifies the SE terminal 41 for the customer handling SE who takes care of the customer of the occurrence of the trouble. Furthermore, the customer information management unit 131 sends an investigation request for the trouble to the investigator terminal 21 together with the trouble number.

Furthermore, after the investigation result of the trouble has been stored in the investigation result storage server 32, the customer information management unit 131 receives a notification request for the customer handling SE from the trouble information management unit 132 together with the customer name. Then, the customer in management unit 131 acquires, from the customer management table 301, the information on the customer handling SE associated with the received customer name, such as the identification information on the customer handling SE, the contact address of the SE, or the like. Then, the customer information management unit 131 sends the customer name and the trouble number to the SE terminal 41 together with a notification of the completion of the investigation.

Furthermore, the customer information management unit 131 manages redundancy of the data that is input by a customer as a part of the management of customer information. Specifically, the customer information management unit 131 monitors the operation of the data processing unit 121 in the storage device 12 and the data processing unit 221 in the storage device 22. If one of the data processing units 121 and 221 writes data, the customer information management unit 131 instructs the data processing unit 121 or 221 that performed the writing to copy the data in the other one of the data processing unit 121 and 221. Consequently, the data becomes redundant and, even if a failure occurs in one of the control servers 11 and 21, the process can be continued in the other data center.

If a trouble occurs in the control server 11 or 21, the trouble information management unit 132 receives a customer name from the customer information management unit 131. Then, the trouble information management unit 132 issues a trouble number associated with the received trouble as a notification. For example, the trouble information management unit 132 may also issue the trouble number by using sequence numbers.

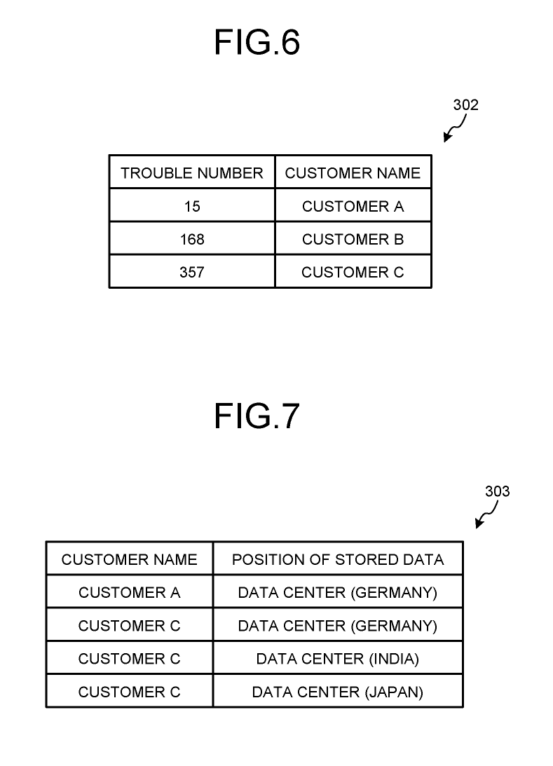

Then, the trouble information management unit 132 associates the issued trouble number with the customer name and then registers the associated trouble number and the customer name. For example, the trouble information management unit 132 registers the association relationship between the trouble number and the customer name by using a trouble management table 302 illustrated in FIG. 6. FIG. 6 is a schematic diagram illustrating an example of a trouble management table. When the registration has been completed, the trouble information management unit 132 sends, to the customer information management unit 131, a notification indicating that an issue of a trouble number has been completed.

Furthermore, if an acquisition request of the investigation information is sent from the investigator terminal 31, the trouble information management unit 132 receives, from the data storage location management unit 133, a notification request of the customer name associated with the trouble number. Then, the trouble information management unit 132 acquires, from the trouble management table 302, the customer name that is associated with the notified trouble number. Then, the trouble information management unit 132 notifies the data storage location management unit 133 of the acquired customer name.

Furthermore, if the investigation result of the trouble is stored in the investigation result storage server 32, the trouble information management unit 132 receives, together with the trouble number from the investigator terminal 31, a notification indicating that the storing of the investigation result has been completed. In response to the notification, the trouble information management unit 132 acquires the customer name associated with the received trouble number from the trouble management table 302. Then, the trouble information management unit 132 not the customer information management unit 131 of the acquired customer name.

The data storage location management unit 133 previously stores therein, for each customer, the data center that is used by each of the customers. For example, the data storage location management unit 133 stores therein a data storage location management table 303 illustrated in FIG. 7. In the data storage location management table 303, the location in which the data of the customer is stored is associated with the customer name. In this case, the data storage location management unit 133 previously holds the information in the data center that is associated with the registered data storage location.

After an investigation request of the trouble is sent from the customer information management unit 131 to the investigator terminal 31, the data storage location management unit 133 receives an acquisition request of investigation information from the investigator terminal 31. A trouble, number is included in the acquisition request for the investigation information. Then, the data storage location management unit 133 sends a notification request for the customer name associated with the trouble number to the trouble information management unit 132. Then, the data storage location management unit 133 receives, from the trouble information management unit 132, the customer name associated with the trouble number specified by the notification request.

Then, the data storage location management unit 133 receives the location in which the data of the received customer name is stored from the data storage location management table 303 and specifies the data center at the storage destination. In the embodiment, a description will be given of a case in which the data of the customer is stored in the data center 1 and the data center 2. The data storage location management unit 133 sends a collection request for the investigation information together with the customer name to the investigation information management units 123 and 223. The data storage location management unit 133 mentioned here corresponds to an example of a “collection instruction unit”.

The control server 21 performs the same operation as that performed by the control server 11. Furthermore, the storage device 22 performs the same operation as that performed by the storage device 12. However, the investigation information management unit 223 does not merge the investigation information and sends the collected investigation information to the investigation information management unit 123 in the storage device 12.

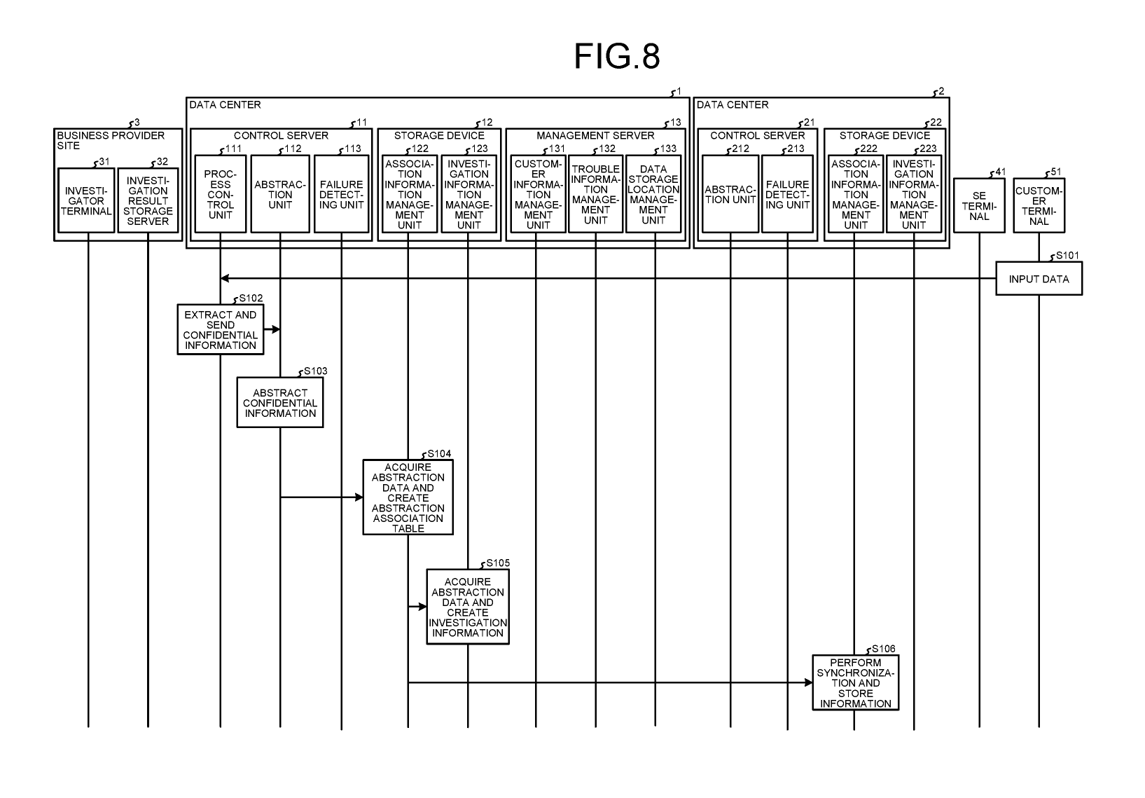

In the following, the flow of a data storing process performed when data is input first time in the information processing system according to the embodiment will be described with reference to FIG. 8. FIG. 8 is a timing chart of a data storing process performed when data is input first time. In FIG. 8, representing the components that are not needed for the data storing process performed when data is input first time may sometimes be omitted.

In response to an instruction received from the customer, the customer terminal 51 inputs the data to the process control unit ill in the control server 11 (Step S101).

The process control unit 111 receives an input of the data from the customer terminal 51. Then, the process control unit 111 extracts confidential information from the received data and sends the extracted confidential information to the abstraction unit 112 (Step S102).

The abstraction unit 112 receives the confidential information from the process control unit 111. Then, the abstraction unit 112 abstracts the confidential information and creates the abstraction data (Step S103).

Then, the abstraction unit 112 sends the created abstraction data and the confidential information to the association information management unit 122.

The association information management unit 122 acquires, from the abstraction unit 112 together with the abstraction data, the confidential information that has not been abstracted. Then, the association information management unit 122 creates an abstraction association table in which the acquired abstraction data is associated with the confidential information (Step S104). In contrast, the process control unit 111 acquires the abstraction data from the abstraction unit 112, replaces the confidential information in the data received from the customer terminal 51 with the abstraction data and allows the data processing unit 121 to write the data.

The investigation information management unit 123 acquires an input of the abstraction data from the association information management unit 122. Then, the investigation information management unit 123 creates investigation information by using the received abstraction data (Step S105). Here, in FIG. 8, the process of creating the investigation information is performed at Step S105 only once; however, in practice, the investigation information management unit 123 repeatedly creates investigation information under a predetermined condition.

Furthermore, the association information management unit 122 sends the created abstraction association table to the association information management unit 222 in the storage device 22. The association In formation management unit 222 receives the abstraction association table from the association information management unit 122, synchronizes the content of the received abstraction association table with the content of the held abstraction association table, and stores the received information in the held abstraction association table (Step S106).

In the embodiment, a case in which a first input of the data is performed on the side of the data center 1 has been described; however, the same operation is also be performed in a case in which an input of the data is performed on the side of the data center 2. Namely, even if an update of the data is performed in either side, synchronization of the abstraction association tables is performed and each of the association information management units 122 and 222 holds the abstraction association table with the same content.

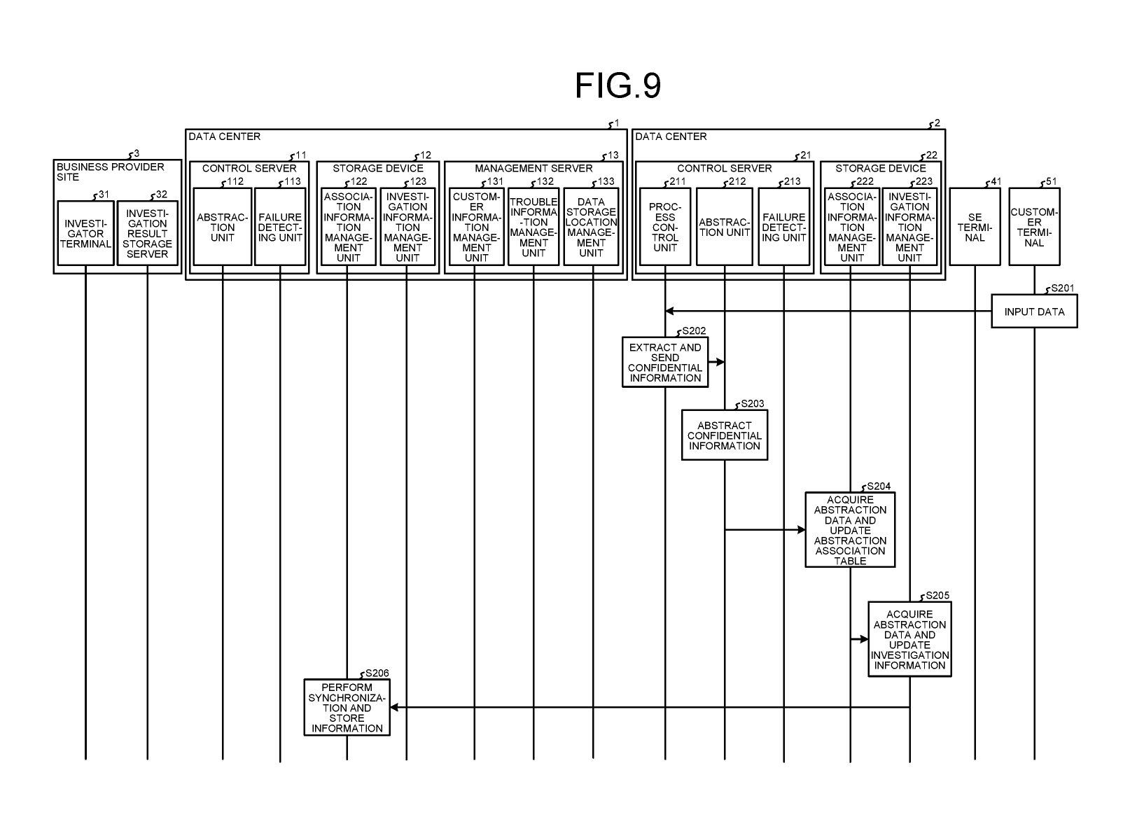

In the following, the flow of the data storing process performed when data is updated in the information processing system according to the embodiment will be described with reference to FIG. 9, FIG. 9 is a timing chart of the data storing process performed when data is updated. In the embodiment, a description will be given of a case in which a customer updates the data by using the data center 2. In FIG. 9, a description of the components that are not needed for the data storing process performed when data is updated may sometimes be omitted.

In response to an instruction received from a customer, the customer terminal 51 inputs data to a process control unit 211 in the control server 21 (Step S201).

The process control unit 211 receives an input of the data from the customer terminal 51. Then, the process control unit 211 extracts confidential information from the received data and sends the extracted confidential information to an abstraction unit 212 (Step S202).

The abstraction unit 212 receives the confidential information from the process control unit 211. Then, the abstraction unit 212 abstracts the confidential information and creates abstraction data (Step S203). Then, the abstraction unit 212 sends the created abstraction data and the confidential information to the association information management unit 222.

The association information management unit 222 acquires, from the abstraction unit 212 together with the abstraction data, the confidential information that has not been abstracted. Then, the association information management unit 222 creates the association between the acquired abstraction data and the confidential information and updates the abstraction association table (Step S204). In contrast, the process control unit 211 acquires the abstraction data from the abstraction unit, replaces the confidential information in the data received from the customer terminal 51 with the abstraction data, and allows the data processing unit 221 to write the data.

The investigation information management unit 223 acquires an input of the abstraction data from the association information management unit 222. Then, the investigation information management unit 223 updates the investigation information by using the received abstraction data (Step S205). Here, in FIG. 9, the process of creating the investigation information is performed at Step S205 only once; however, in practice, the investigation information management unit 223 repeatedly creates investigation information under a predetermined condition.

Furthermore, the association information management unit 222 sends the created abstraction association table to the association information management unit 122 in the storage device 12. The association information management unit 122 receives the abstraction association table from the association information management unit 222, synchronizes the content of the received abstraction association table with the content of the held abstraction association table, and performs an update (Step S206).

In the embodiment, a case in which an update of the data is performed on the side of the data center 2; however, the same operation is also be performed in as case in which an update of the data is performed on the side of the data center 1. Namely, event if an update of the data is performed in either side, synchronization of the abstraction association table is performed and each of the association information management units 122 and 222 holds the abstraction association table with the same content.

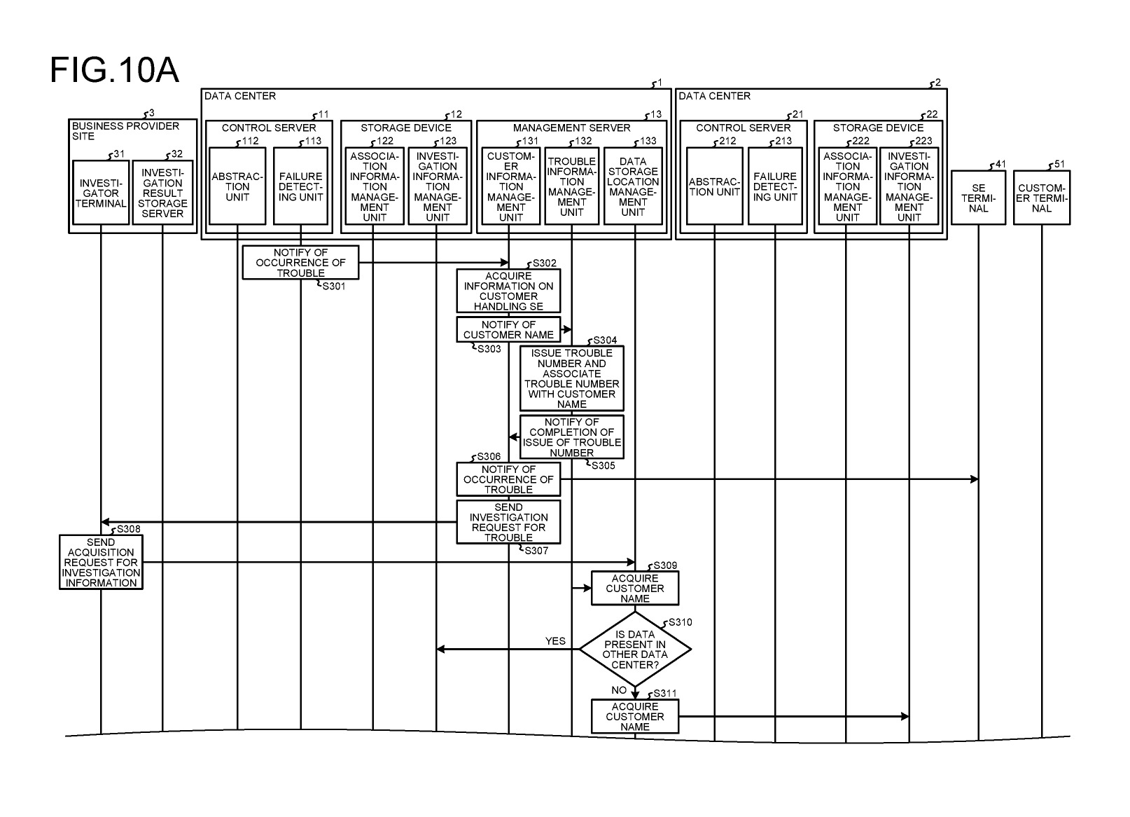

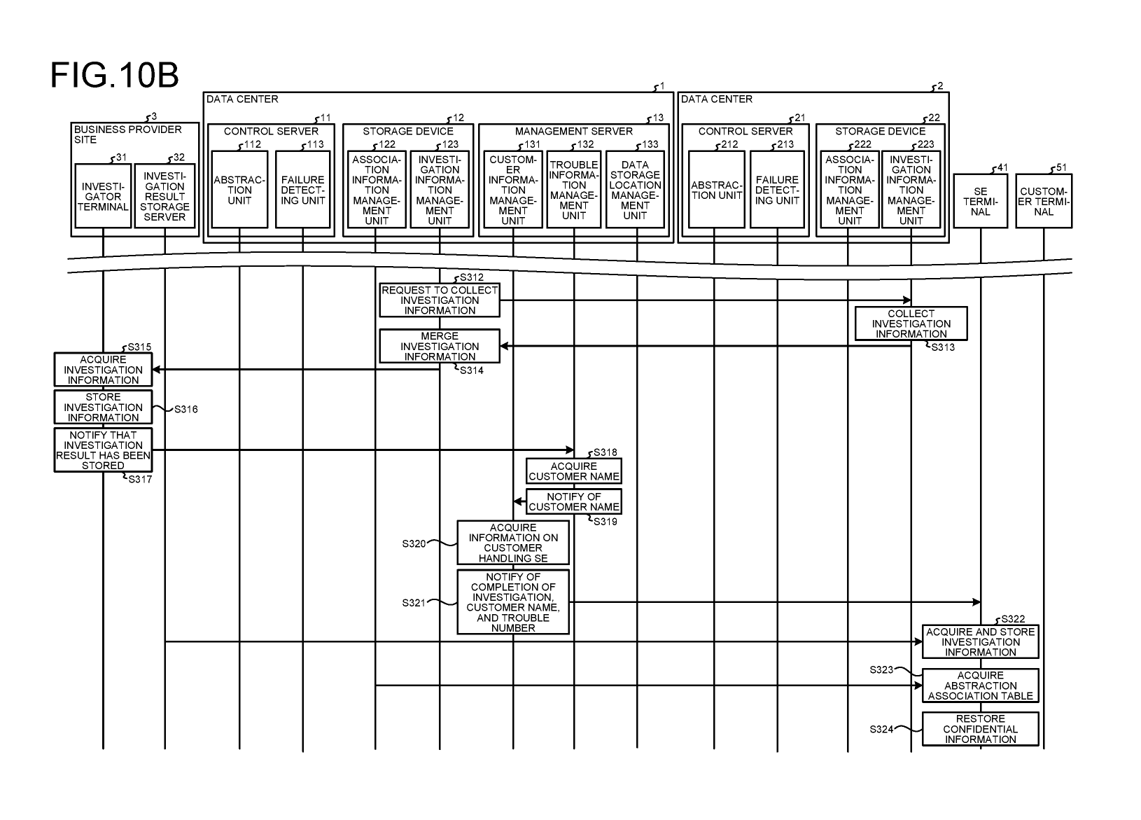

In the following, the flow of a process of handling a trouble performed when the trouble occurs in the information processing system according to the embodiment will be described with reference to FIGS. 10A and 10B. FIGS. 10A and 10B are timing charts each illustrating a process of handling a trouble performed when the trouble occurs. FIGS. 10A and 10B represent a series of processes and, furthermore, the processes illustrated in FIG. 10B are performed after the processes illustrated in FIG. 10A. In the embodiment, a description will be given of a case in which a trouble occurs in the control server 11. Furthermore, in FIGS. 10A and 10B, a description of the components that are not needed for handling the trouble when the trouble occurs may sometimes be omitted.

The failure detecting unit 113 detects that a trouble has occurred and notifies the customer information management unit 131 of the occurrence of the trouble (Step S301). In the notification of the occurrence of the trouble, information on the customer name related to the subject trouble is included.

The customer information management unit 131 receives a notification of the occurrence of the trouble from the failure detecting unit 113. Then, the customer information management unit 131 acquires, from the customer management table, the identification information and the SE contact address of the customer handling SE that is associated with the customer name included in the notification of the occurrence of the trouble as the information on the customer handling SE for the customer (Step S302).

Then, the customer information management unit 131 notifies the trouble information management unit 132 of the customer name (Step S303).

The trouble information management unit 132 acquires the customer name from the customer information management unit 131. Then, the trouble information management unit 132 issues a trouble number, associates the trouble number with the customer name, and stores the association relationship (Step S304).

Then, the trouble information management unit 132 notifies the customer information management unit 131 indicating that the issue of the trouble number has been completed (Step S305).

The customer information management unit 131 receives the completion of the issue of the trouble number from the trouble information management unit 132. Then, the customer information management unit 131 notifies the SE terminal 41 of the occurrence of the trouble (Step S306).

Furthermore, the customer information management unit 131 sends, to the investigator terminal 31, an investigation request for the trouble by using the information on the SE contact address or the like that is registered in the customer management table (Step S307). A trouble number is included in the investigation request for the trouble in order to specify which of the troubles is to be investigated as a request.

The investigator terminal 31 receives the investigation request for the trouble from the customer information management unit 131, displays the received request on a display or the like, and provides the request to an investigator. The investigator checks the investigation request for the trouble and starts investigating the trouble. In response to the instruction received from the investigator, the investigator terminal 31 sends an acquisition request for the investigation information to the data storage location management unit 133 (Step S308). A trouble number of the trouble targeted for the investigation is included in the acquisition request in this investigation information.

The data storage location management unit 133 receives the acquisition request for the investigation information from the investigator terminal 31. Then, the data storage location management unit 133 requests the trouble information management unit 132 to provide the customer name that is associated with the trouble number included in the acquisition request for the investigation information. The trouble information management unit 132 acquires the customer name associated with the trouble number from the trouble management table and notifies the data storage location management unit 133 of the customer name. The data storage location management unit 133 acquires the customer name associated with the trouble number from the trouble information management unit 132 (Step S309).

Then, the data storage location management unit 133 determines whether the data that is used by the customer and that is associated with the acquired customer name is present in the other data center that is other than the data center (Step S310).

If the data on the subject customer is not present in the other data center (No at Step S310), the process proceeds to Step S311. Namely, the data storage location management unit 133 requests the investigation information management unit 123 to collect the investigation information. Then, the investigation information management unit 123 collects the investigation information (Step S311).

In contrast, if the data on the subject customer is present in the other data center (Yes at Step S310), the following process is performed in parallel with the process performed at Step S311. In the embodiment, a description will be given of a case in which the data on the subject customer is present in the data center 2. The data storage location management unit 133 requests the investigation information management unit 223 to collect, the investigation information (Step S312). Then, in response to the request for the collection of the information, the investigation information management unit 223 collects the investigation information (Step S313). Thereafter, the investigation information management unit 223 sends the collected investigation information to the investigation information management unit 123.

If the investigation information management unit 123 has received the investigation information in the other data center, the investigation information management unit 123 merges the received investigation information with the investigation information collected by the investigation information management unit 123 itself and sets the merged information as a single piece of investigation information (Step S314). Then, the investigation information management unit 123 sends the investigation information to the investigator terminal 31.

Then, the investigator terminal 31 acquires the investigation information from the investigation information management unit 123 (Step S315). Then, investigator terminal 31 provides the acquired investigation information to the investigator. The investigator investigates on the basis of the investigation information. Thereafter, the investigator instructs the investigator terminal 31 to store the investigation result.

In response to the instruction received from the investigator, the investigator terminal 31 allows the investigation result storage server 32 to store therein the investigation result (Step S316).

Furthermore, the investigator terminal 31 notifies the trouble information management unit 132 that the investigation result has been stored (Step S317). The notification of the storing of the investigation result includes therein the trouble number indicating which of the trouble is associated with the investigation result.

The trouble information management unit 132 receives the notification of the storing of the investigation result from the investigator terminal 31. Then, the trouble information management unit 132 acquires, from the trouble management table, the customer name that is associated with the trouble number included in the notification of the storing of the investigation result (Step S318). Then, the trouble information management unit 132 notifies the customer information management unit 131 of the acquired customer name (Step S319).

The customer information management unit 131 acquires the customer name from the trouble information management unit 132. Then, the customer information management, unit 131 acquires, from the customer management table as the information on the customer handling SE, the identification information and the SE contact address of the customer handling SE associated with the acquired customer name (Step S320).

The customer information management unit 131 sends the completion of the investigation, the customer name, and the trouble number to the SE terminal 41 (Step S321). The SE terminal 41 notifies the customer handling SE of the completion of the investigation together with the customer name and the trouble number.

Thereafter, in response to an instruction received from the customer handling SE, the SE terminal 41 acquires the investigation information from the investigation result storage server 32 and stores the investigation information (Step S322).

Furthermore, in response to an instruction received from the customer handling SE, the SE terminal 41 acquires the abstraction association table from the association information management unit 122 (Step S323).

Then, for the abstraction data included in the investigation information, the SE terminal.41 restores the confidential information by using the abstraction association table (Step S324). Thereafter, the SE terminal 41 provides the customer handling SE with the investigation information that is obtained by restoring the abstraction data to the confidential information.

As described above, when the trouble is handled, because only the customer handling SE who directly gives an explanation to a customer can be aware of the confidential information and the investigator or the like does not access the confidential information, it is possible to improve the security.

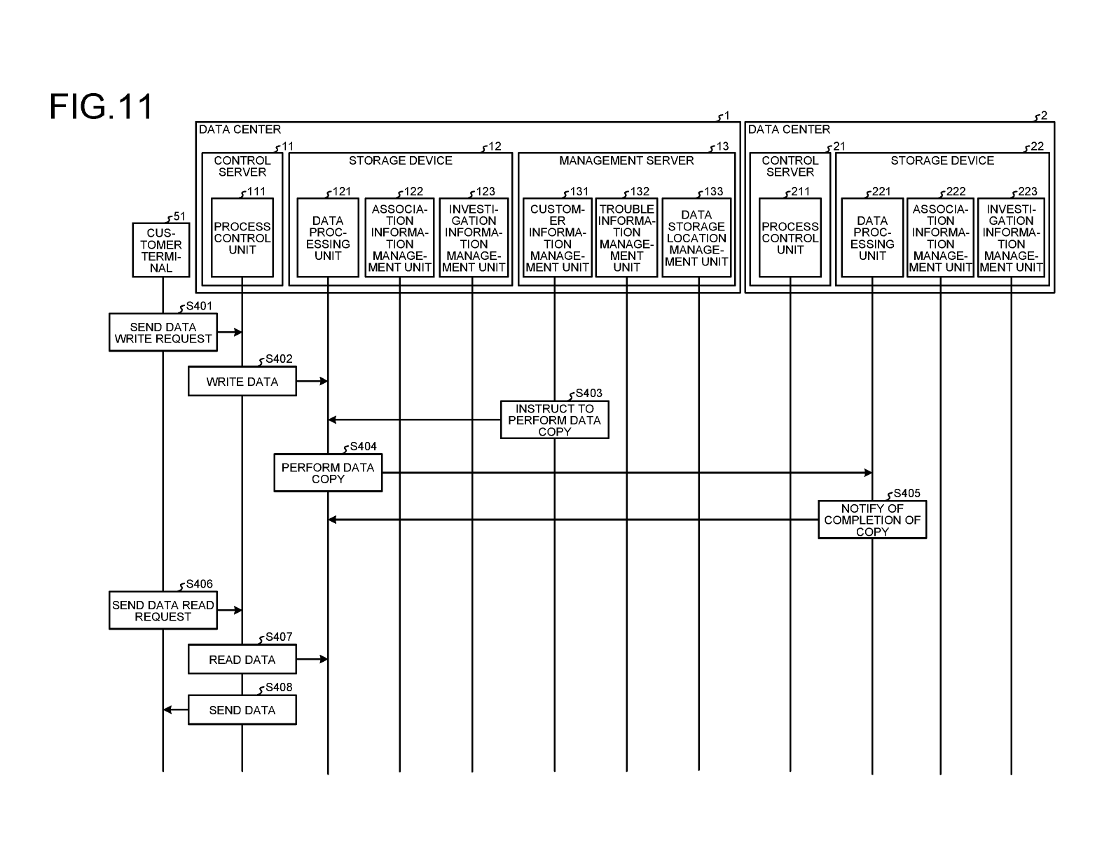

In the following, the flow of a duplicating process of data between the data centers 1 and 2 will be described with reference to FIG. 11. FIG. 11 is a time chart of a duplicating process of data between data centers. In FIG. 11, the flow of the writing process of data will be described first and then the flow of the reading process of the data will be described. Furthermore, in FIG. 11, a description of the components that are not needed for the writing and the reading data may sometimes be omitted.

The customer terminal 51 sends a data write request to the process control unit 111 (Step S401).

The customer process control unit 111 receives the data write request from the customer terminal 51. Then, the process control unit 111 allows the data processing unit 121 to write the data (Step S402).

The customer information management unit 131 monitors the operation of the data processing unit 121. Then, when the data processing unit 121 writes the data, the customer information management unit 131 instructs the data processing unit 121 to perform a data copy (Step S403).

The data processing unit 121 receives the instruction of the data copy from the customer information management unit 131. Then, the data processing unit 121 performs the data copy with respect to the data processing unit 221 (Step S404).

When the data processing unit 221 completes the copy of the data acquired from the data processing unit 121, the data processing unit 221 notifies the data processing unit 121 of the completion of the copy (Step S405).

Furthermore, the customer terminal 51 sends a read request for the data to the process control unit 111 (Step S406).

The process control unit 111 reads the data from the data processing unit 121 (Step S407). Specifically, the process control unit 111 requests the data processing unit 121 to acquire the data and acquires the data sent from the data processing unit 121, whereby the process control unit 111 reads the data.

Then, process control unit 111 sends the read data to the customer terminal 51 (Step S408).

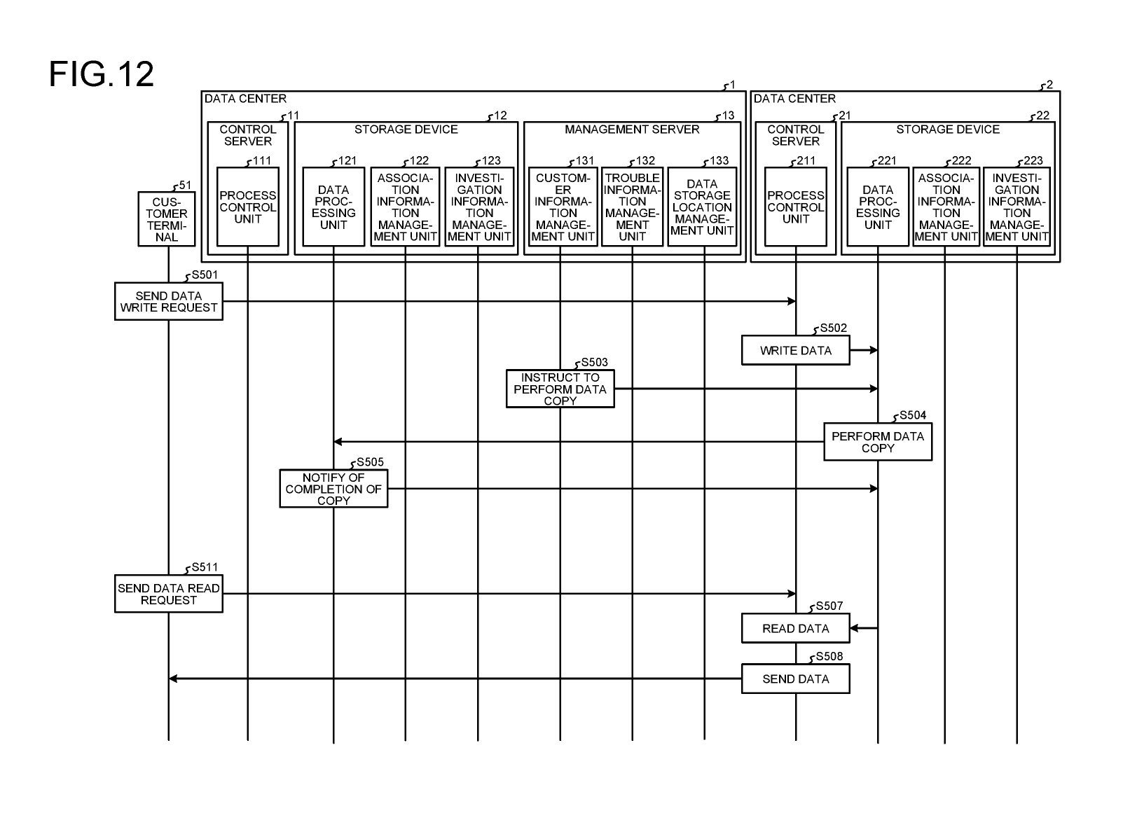

In the following, the flow of a duplicating process of data performed between the data centers 1 and 2 after the control server 11 has failed and the process is changed such that the process to be performed by the control server 11 is changed to the control server 21 will be described with reference to FIG. 12. FIG. 12 is a timing chart of a process of providing a service after the data center is changed. In FIG. 12, the flow of the writing process of the data will be described and then the flow of the reading process of the data will be described. Furthermore, in FIG. 12, a description of the components that are not needed for the writing and the reading data may sometimes be omitted.

In this case, because the processing request sent to the process control unit 111 is changed such that the processing request is to be sent to the process control unit 211, the customer terminal 51 sends a data write request to the process control unit 211 (Step S501).

The process control unit 211 receives the data write request from the customer terminal 51. Then, the process control unit 211 allows the data processing unit 221 to write the data (Step S502).

The customer information management unit 131 monitors the operation of the data processing unit 221. Then, if the data processing unit 221 writes the data, the customer information management unit 131 instructs the data processing unit 221 to copy the data (Step S503).

The data processing unit 221 receives the instruction to perform the data copy from the customer information management unit 131. Then, the data processing unit 221 performs the data copy with respect to the data processing unit 121 (Step S504).

When the data processing unit 121 completes the copy of the data acquired from the data processing unit 221, the data processing unit 121 notifies the data processing unit 221 of the completion of the copy (Step S505).

Furthermore, the customer terminal 51 sends a read request for the data to the process control unit 211 (Step S506).

The process control unit 211 reads the data from the data processing unit 221 (Step S507).

Then, the process control unit 211 sends the read data to the customer terminal 51 (Step S508).

As described above, even if the data center 1 that is in charge of the process is changed to the data center 2, because the data is redundant, the process is not interrupted and thus the customer can continuously receive the service.

Hardware Configuration

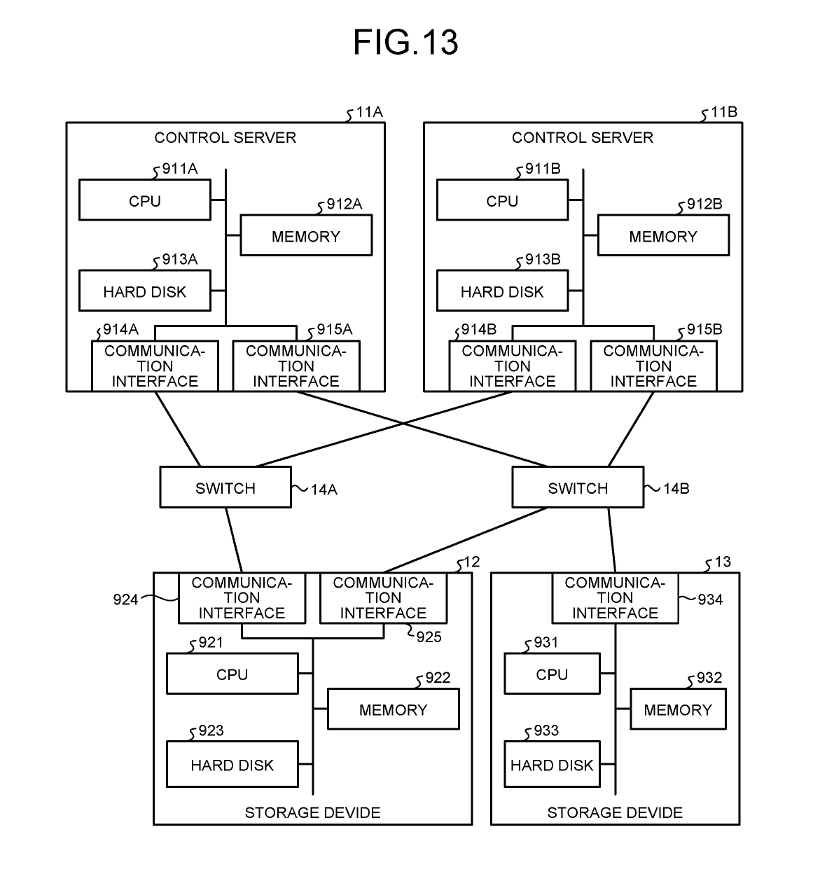

In the following, the hardware configuration of the data centers 1 and 2 according to the embodiment will be described with reference to FIG. 13. FIG. 13 is a block diagram illustrating the hardware configuration of the data center. In the embodiment, the data center 1 will be described as an example; however, the data center 2 has also the same hardware configuration. Each of the control server 11A, the control server 115, the storage device 12, and the management server 13 is connected via the switch 14A and 14B. The switch 14A and 14B mentioned here correspond to the switch 14 in FIG. 1.

The control server 11A includes a central processing unit (CPU) 911A, a memory 912A, a hard disk 913A, and communication interfaces 914A and 915A. Furthermore, the control server 115 includes a central processing unit (CPU) 911B, a memory 912B, a hard disk 913B, and communication interfaces 914B and 915B. Both of the control server 11A and the control server 11B have the same hardware configuration and the same function; therefore, in a description below the control server 11A will be described as an example.

The CPU 911A is connected the memory 912A, the hard disk 913A, and the communication interfaces 914A and 915A by a bus.

The communication interfaces 914A and 915A are interfaces for performing communication between the storage device 12 and the management server 13. However, in practice, the control server 11A may also include a communication interface for connecting to the Internet, an interface for performs communication with the control server 21, or the like.

The hard disk 913A stores therein various kinds of programs including the programs that implement the functions performed by the process control unit 111, the abstraction unit 112, and the failure detecting unit 113.

The CPU 911A reads the various kinds of the programs from the hard disk 913A, loads the programs into the memory 912A, and executes the loaded programs. Consequently, the CPU 911A and the memory 912A implements the function performed by the process control unit 111, the abstraction unit 112, and the failure detecting unit 113.

Furthermore, FIG. 13 illustrates the hardware related to the operation performed in the storage system. The storage device 12 includes a CPU 921, a memory 922, a hard disk 923, and communication interfaces 924 and 925.

The communication interface 924 is an interface for performing communication be ween the control servers 11A and 11B and the management server 13.

The hard disk 923 stores therein various kinds of programs including the programs that implement the functions performed by the data processing unit 121, the association information management unit.122, and the investigation information management unit 123.

The CPU 921 reads various kinds of programs from the hard disk 923, loads the programs into the memory 922, and executes the programs. Consequently, the CPU 921 and the memory 922 implement the functions performed by the association information management unit 122 and the investigation information management unit 123.

Furthermore, the management server 13 includes a CPU 931, a memory 932, a hard disk 933, and a communication interface 934.

The communication interface 934 is an interface for performing communication between the control servers 11A and 11B and the storage device 12.

The hard disk 933 stores therein various kinds of programs including programs that implement the functions performed by the customer information management unit 131, the trouble information management unit 132, and the data storage location management unit 133.

The CPU 931 reads the various kinds of programs from the hard disk 933, loads the programs into the memory 932, and executes the loaded programs. Consequently, the CPU 931 and the memory 932 implement the functions performed by the customer information management unit 131, the trouble information management unit 132, and the data storage location management unit 133.

As described above, the information processing system according to the embodiment can request for investigation without disclosing confidential information to an investigator or the like and, furthermore, inside the storage system, a process is performed in a state in which the confidential information is abstracted. Namely, the information processing system according to the embodiment can suppress the disclosure of the confidential information to a minimum needed level and thus it is possible to reduce a decrease in the security level. Consequently, it is possible to make a customer feel at ease, which makes it possible for the customer to easily permit the collection of the investigation information. Furthermore, the customer handling SE who directly handles the customer can appropriately explain the investigation content of the trouble with respect to the customer by specially obtaining the abstraction association table.

Furthermore, in an environment that implements a cloud service, across a plurality of data centers, it is conceivable that the data of the customer is distributed to each of the data centers. In such a case, when the investigation information is gathered, the investigation information may possibly flow through a network that connects the data centers. In this case, if the confidential information is included in the investigation information, the confidential information may possibly be stolen during the migration of the investigation information between the data centers, which is a dangerous state, and, during this time period, the security level is decreased. In the information processing system according to the embodiment, because the confidential information is included in the investigation information in a state in which the confidential information is abstracted, even if the investigation information is stolen, it possible to reduce a risk of the confidential information from being leaked. Consequently, in regard to this point, the information processing system according to the embodiment can reduce a decrease in the security level.

In the above, description, a case in which a plurality of data centers are present; however, even if a single data center is used, by using the abstracted confidential information and suppressing the disclosure destination to a minimum needed level, it is possible to reduce a decrease in the security level.

According to an aspect of an embodiment of the information processing system and the control method of the information processing system disclosed in the present invention, an advantage is provided in that it is possible to suppress a decrease in a security level.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing system comprising:
an information processing apparatus that processes data that is input;
a management device that manages the information processing apparatus;
a first terminal device; and
a second terminal device, wherein
the information processing apparatus includes
a converting unit that converts confidential information included in the data to alternative information,
an association information management unit that manages association information that indicates the association of the alternative information which is created by the converting unit and the confidential information,
a process control unit that performs a process by using the data obtained by converting the confidential information to the alternative information, and
an investigation information management unit that creates, by using the alternative information, investigation in indicating the operation of the information processing apparatus and that collects, from among the pieces of the investigation information, investigation information related to a trouble that has occurred in the information processing apparatus, and
the management device includes
a collection instruction unit that causes the Investigation information management unit to collect, in accordance, with an acquisition request for the investigation information related to the trouble that has occurred in the information processing apparatus received from the first terminal device, the investigation information related to the trouble, and
the second terminal device restores the alternative information included in an investigation result obtained on the basis of the investigation information to the confidential information by using the association information.

2. The information processing system according to claim 1, further comprising an investigation result storing unit that stores therein the investigation result obtained on the basis of the investigation information, wherein the second terminal device acquires the investigation information from the investigation result storing unit.

3. The information processing system according to claim 1, wherein the information processing system includes a plurality of the information processing apparatuses that are redundant, and
the association information is subject to synchronization between the association information management units in the plurality of information processing apparatus.

4. The information processing system according to claim 3, wherein
the information processing system includes the plurality of the information processing apparatuses that are redundant, and
when the process control unit included in one of the information processing apparatuses from among the plurality of the process control units in the information processing apparatuses fails, the process control unit in the other one of the information processing apparatuses processes a processing request that is requested to the failed process control unit.

5. The information processing system according to claim 1, wherein
the information processing apparatus includes a plurality of virtual machines,
the process control unit performs a process that is associated with each of a plurality of users, and
the investigation information management unit collects, for each user or each virtual machine, investigation information related to the trouble that has occurred in the information processing apparatus.

6. A control method of an information processing system that includes an information processing apparatus that processes data that is input, a management device that manages the information processing apparatus, a first terminal device, and a second terminal device, the control method comprising:
converting, performed by the information processing apparatus, confidential information included in the data to alternative information;
managing, performed by the information processing apparatus, association information that indicates the association of the alternative information which is created at the converting and the confidential information;
performing a process, performed by the information processing apparatus, by using the data obtained by converting the confidential information to the alternative information;
creating, performed by the information processing apparatus using the alternative information, investigation information indicating the operation of the information processing apparatus;
collecting, performed by the information processing apparatus from among the pieces of the investigation, investigation information related to a trouble that has occurred in the information processing apparatus;
causing, performed by the management device, the information processing apparatus to collect the investigation information related to the trouble in accordance with an acquisition request for the investigation information related to the trouble that has occurred in the information processing apparatus received from the first terminal device; and
restoring, performed by the second terminal device, the alternative information included in an investigation result obtained on the basis of the investigation information to the confidential information by using the association information.
